(19) United States
(12) Patent Application Publication
(10) Pub. No.: US 2005/0198302 A1
(43) Pub. Date: Sep. 8, 2005

(54) Multi-client support

(75) Inventors: Brian Joseph Ewanchuk, Redmond, WA (US); James Stuart Johnson, Redmond, WA (US); Mark Gerald Favero, Seattle, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/748,769

(22) Filed: Dec. 29, 2003

(51) Int. Cl. G06F 15/16

(52) U.S. Cl. 709/227

(57) ABSTRACT

A connection manager manages a connection while plural applications issue connection requests and disconnection requests. In one such example, a data structure maintains a record of applications requesting a connection, and removes applications requesting disconnections. While at least one application remains in the record, the connection manager maintains the connection upon a disconnection request. In another example, a connection manager removes a terminated process from the record.

### TECHNICAL FIELD

The technical field relates to remote connection shared in multi-processing devices.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Microsoft Corporation, as an internet service provider (ISP), delivered MSN 8.0 software for connecting to the Internet. The software supported dial-up connections using a remote access service (i.e., Remote Access Service (RAS)). When a first application requested a dial-up connection, a dialer component provided that connection using the remote access service. A dial-up connection was established in response to the connection request, and later, a second application requesting a dial-up connection would share the established connection. However, if the first application requested a disconnection while the second application was still using the connection, the connection was terminated.

### SUMMARY

The described technologies provide methods and systems for managing temporally overlapping connection and disconnection requests by plural applications to a shared connection.

In one example, a connection manager manages a connection while plural applications issue connection requests and disconnection requests. In one such example, a data structure maintains a record of applications requesting a connection, and removes applications requesting disconnections. While at least one application remains in the record, the connection manager maintains the connection upon a disconnection request. In another example, a connection manager removes a terminated process from the record.

In another example, a method receives requests for connections and disconnections from plural applications. The method connects a device to a network node upon a connection request from an application when no connection exists. The method disconnects a device from the network node when a disconnection request is received from the last application using the connection. The method maintains information about applications using the connection in a data structure.

Additional features and advantages will be made apparent from the following detailed description, which proceeds with reference to the accompanying drawings.

### BRIEF DESCRIPTION OF THE DRAWINGS

FIG. 1 is an exemplary block diagram of a system with a device for connecting to a network.

FIG. 2 is an exemplary block diagram of a device including plural applications, an operating system, and other software and hardware for managing a connection to a remote resource.

FIG. 3 is an exemplary block diagram of software components involved in establishing a connection to remote resources.

FIG. 4 is an exemplary time line chart of overlapping use of a shared connection.

FIG. 5 is an exemplary block diagram of a system for sharing a connection to a network.

FIG. 6 is an exemplary block diagram showing a system of components involved in managing multiple processes sharing a connection.

FIG. 7 is an exemplary diagram of a data structure holding state indicating multiple client processes sharing a connection.

FIG. 8 is a flow chart of a method for managing connections.

FIG. 9 is a flow chart of a method for managing disconnections.

FIG. 10 is a flow chart of an exemplary method for managing terminated processes.

FIG. 11 is a flow chart of an exemplary method for managing a shared connection.

FIG. 12 is a block diagram of exemplary system components establishing a connection.

FIG. 13 is a block diagram of an XML file for storing connector information.

FIG. 14 is a block diagram of a distributed computer system implementing the described technologies.

### DETAILED DESCRIPTION

### Overview

The following examples describe methods and systems for managing a connection shared by plural applications on a computing device. The plural applications are using the connection to access remote resources on a network (e.g., web pages, e-mail servers, wireless telephone networks, database services, etc). The computing device is any type of device with a processor, memory, and a hardware component for connecting to the network. The hardware component is a modem or other transmitter and receiver that communicates with the remote resources via the connection. The connection is via any communication protocol, wireless or otherwise.

### Exemplary Network Connection

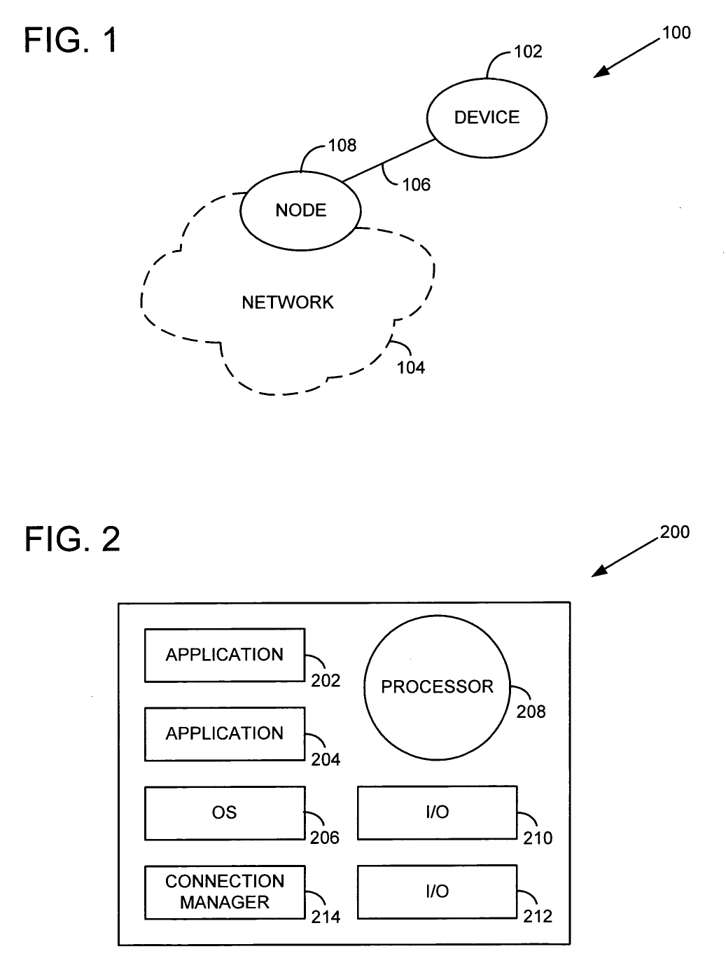

FIG. 1 is an exemplary block diagram of a system for connecting a device to a remote resource. In one example, a remote resource is located at a node with which the device is communicating 108. In another example, the system includes a network 104, and remote resources exists at connecting node 108, and at one or more other nodes on the network 104. In another example, a client 102 is a computer and is connecting to the Internet via a dial-up connection 106 to another computer 108. In such an example the other computer 108 is an Internet service provider (ISP) that receives the dial-up connection request from the device 102, and provides access to the remote resource(s). In another example, the device 102 is a wireless device such as a wireless telephone, a wireless personal assistant, or other wireless device, and the connection is a wireless connection.

### Exemplary Device

FIG. 2 is an exemplary block diagram of a device including plural applications 202, 204, a multi-processing operating system 206, and other software and hardware for managing a connection to a remote resource. The device also includes a processor 208 and one or more input-output (I/O) device(s) 210, 212. In another example, the I/O device comprises a modem (whether internal or external). In one example, the I/O device further includes a display, a mouse, a key entry, and/or an audio device. In one example, the display includes screen touch entry capabilities. The client is a PC, a cell phone, or other electronic device containing two or more applications 202, 204 requiring access to a remote computer and/or network. In the case of a network, the network is the Internet, a wireless telephone network, a satellite network, and/or any other network or cominbations of networks required to access and transfer the remote resource(s). In one example, the client includes a connection manager 214 that manages a connection for two or more applications requesting access to remote resource(s). A device also comprises software and hardware, for transmitting and receiving with a network node providing access to a remote resource(s).

### Exemplary Applications

A device contains two or more applications requesting remote resources. Applications comprise any software requesting remote services. This does not require the application to have state indicating that the resource is remote, though it may. An application may request a resource that a device system service determines is a resource remote from the device. Further, an application may request a resource and a system service determines that a remote resource is required in order to perform the requested system service. Finally, system services also require remote resources from time to time. Thus, any software requesting a remote resource or causing other software to request a remote resource is contemplated as an application requesting a connection to a remote resource(s).

The types of applications that run on devices, whether wireless or otherwise, is well known in the arts, such as voice services, e-mail services, audio services, video services, database services, Internet services, etc.

### Exemplary Overlapping Connection Sessions

Prior to the described technologies, an application could disconnect a connection pipe while one or more other application(s) were still depending on it.

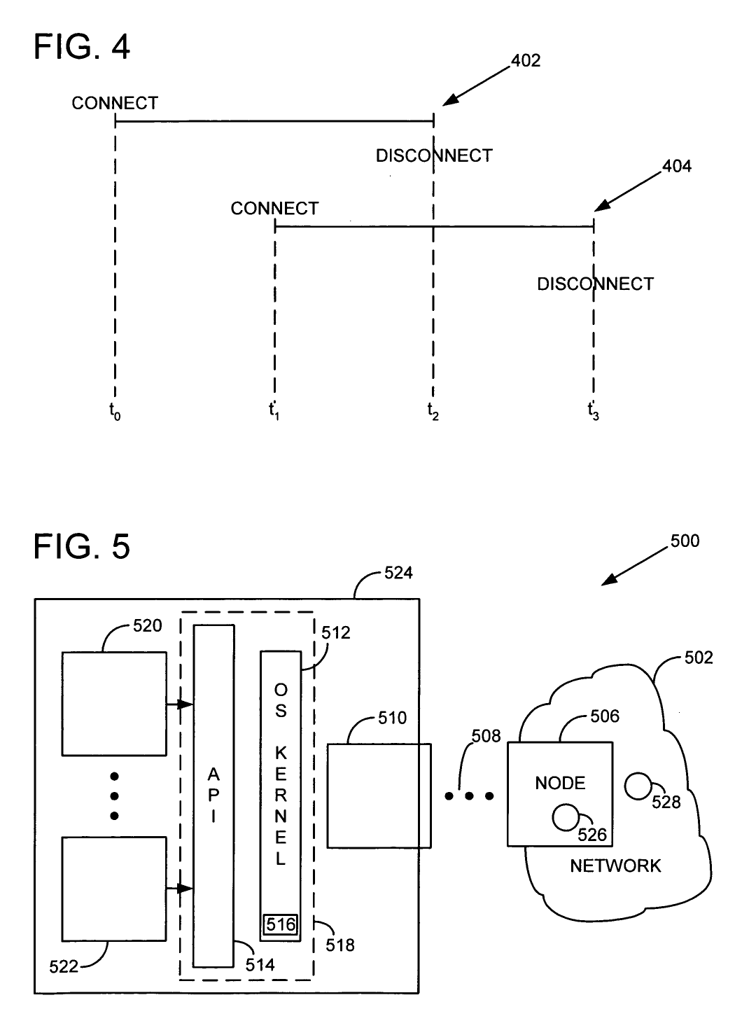

FIG. 4 is an exemplary time line chart of overlapping use of a connection. At time t₀, a first application 402 requests a connection to the shared resource and at time t₂ requests a disconnection. While the first application is accessing a remote resource, a second application 404 requests a remote resource at time t₁. When the first application calls disconnect at time t₂, the shared resource is disconnected at time t₂ and is not available to the second application after time t₂. Since the second application 404 would otherwise have used the connection until time t₃, the connection must be re-established. Instead, using the described technologies, a connection remains open until released by all parties utilizing the resource. Thus, using the technology described herein, the shared resource remains open from t₀ until t₄. Additionally, if a user indicates via a network graphical icon to terminate all connections manually, then the connection manager will terminate the connection for all connected applications.

### Exemplary Connections

In one example, a client 200 is a personal computer and an application 202 is an Internet browser. A user opens the browser application and types www.espn.com into the address location. This begins a process of obtaining an Internet connection.

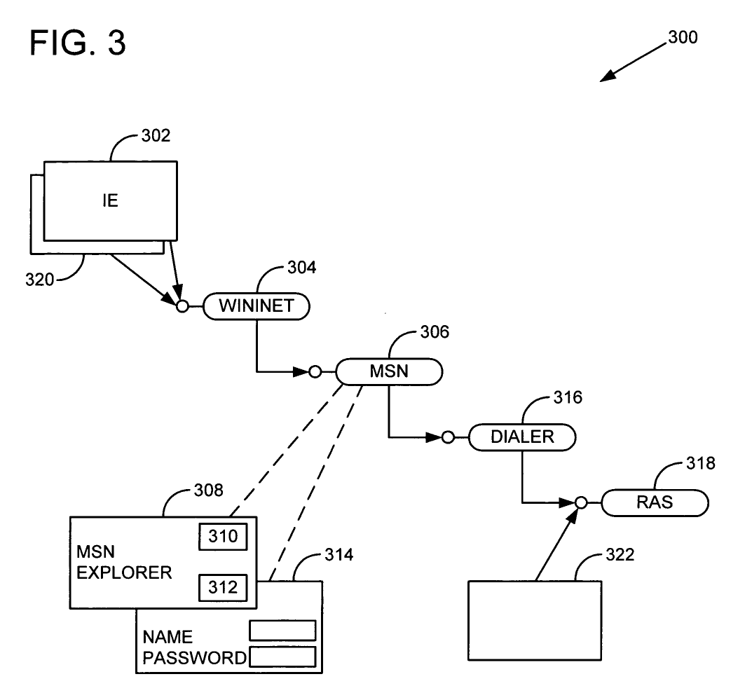

FIG. 3 is an exemplary block diagram of software components involved in establishing a connection to a remote resource. In this example, an application requesting network access is the Internet Explorer from Microsoft Corporation 302. If a user attempts to access a web server on the Internet (e.g., www.espn.com), the application requests the web server, and a Microsoft Windows operating service component called “Wininet” 304 determines whether an Internet connection is established. For example, if the computer was already connected on a local area network, then no network connection needs to be established. However, in this example, since no connection is yet established, and Wininet determines that the computer is set to use a dial-up connection, Wininet invokes a Default Dial up networking component which invokes the MSN Explorer component 306, which generates a window 308 that includes user identification tiles 310-312, and a window 314 for obtaining identification/authentication information. The MSN Explorer component 306 calls a dialer component 316 (e.g., Connection Manager) to established a pipe to the remote ISP server. Once the pipe is established with the ISP, the application 302 can communicate with a remote resource (e.g., the web server www.espn.com).

The Connection Manager component uses a remote access server component (RAS) 318 to establish the pipe with the ISP. The RAS component dials up the ISP over local telephone lines. On the ISP, another server receives the telephone call and authenticates the call with a software component called a Network Authentication Server (NAS), not shown.

When the Connection Manager component asks RAS to provide a connection, it provides RAS with parameters such as the number to call at the ISP, credentials required to complete the connection, and other parameters defining the requested connection. The RAS component returns a handle to that session which includes a ticket to identify the session.

When the application has completed the session using the established pipe, the application 302 calls disconnect (e.g., InternetAutodialHangup( )) on Wininet 304.

Later, when this or another application requests connection to a remote resource, these same components are used to create a pipe to the ISP.

If a second application 320 requests access to a remote resource while the pipe remains open as established for a first application 302, then the second application would use the same pipe to the ISP as the first application. For example, the second application requests access to a remote resource from Wininet 304, and since the pipe is already established, the pipe is shared by the two applications. Prior to the creation of the described technologies, if the application that established the pipe requested disconnection, then the pipe would be disconnected while the other application still intended to use a remote resource via the pipe. One of the features of the created technologies is to track information about the plural applications and maintain the pipe when one of the applications requests a disconnection.

When an application requests access to a remote resource, Wininet either allows access to established communications (e.g., a LAN, or a pipe), or blocks activity until the connection is established as described above.

As data is received on the pipe intended for one of the applications, it is directed to that application. In the case of TCP/IP, Wininet assigns a communications port to each application, and packets sent and received via that port are directed to the corresponding application. This protocol specific information is known in the arts for the different types of networks, wireless or otherwise.

In another example, an application 322 requests a connection directly from the RAS component 318. In this example, the dialer component 316 is registered as a custom dialer (e.g., registered as a component in a system registry) in the registry. In this case, the RAS component consults the registry and requests the dialer to perform the dialing function. The dialer would establish the telephone connection via RAS, and RAS returns a handle to the dialer, and the dialer returns a handle to the calling component. This handle is used by the component to communicate over the connection.

There are many diverse ways that request are generated for remote resources. Since these resources are remote, a communication pipe is established to one or more remote computers. Often a dialer is used to assemble the content required to populate the input parameters on a call to a RAS component.

In one example, a connector component assembles the data required to invoke a dial function on a RAS component.

### Exemplary Multiple Connection Requests

FIG. 5 is an exemplary block diagram of a system for sharing a connection to a network. As shown, a device 524 includes plural applications 520, 522 that need to utilize one or more remote resource 526, 528 on a remote computer or on a network 502, whether wireless or otherwise. The device 524 communicates with one or more node(s) 506 on the network over a connection 508 in order to communicate with remote resources available on the network. The shared connection 508 is supported through any communications protocol whether wired or wireless, such as a LAN, telephone lines, cellular wireless, wi-fi, blue tooth, etc. For example, the device includes a hardware component 510 (e.g., a modem, transmitter/receiver, etc.) that communicates via the connection 508, with a node 506 of the network. When plural applications have requested a connection, the connection is a shared connection. The device 524 communicates with plural nodes on the network in cases where the device is mobile, and the plural nodes hand-off communications with the device as the device moves relative to the plural nodes (e.g., wireless phones and other wireless devices). The hardware component 520 that communicates with the network 502 via the shared connection 508 on behalf of the device can be internal or external to the device 524.

In one example, the device 524 is a personal computer, the shared connection is a dial-up connection 508, the hardware component 510 is an internal modem, the node 506 is an ISP, the remote resources are web servers 528, 526, and the shared connection 508 is “shared” by two application 520, 522 (e.g., a browser, a multimedia player) requesting web services.

The device 524 includes an operating system kernel 512 exposing an application programming interface (API) 514 that the plural applications use to obtain access to system services. When an application 520 needs to obtain remote services at a network 502, the OS establishes a connection 508 to the network 502 using the hardware component 510. The hardware component 510 is a device that establishes a connection with a network, transmits and receives data over that connection, and terminates the connection. For example, if the hardware component is a modem or other transmitter or receiver, the OS will access a driver component 516 to send and receive communications via the hardware component 510 to the network. For example, if the hardware component is a modem, the driver component is a modem driver.

As shown, the device also comprises logic 518 for managing shared use of the connection 508 (e.g., a shared connection). The logic for managing the shared connection holds state information about each application (i.e., process) utilizing the shared connection 508. The logic for managing a shared connection 518 is shown with dotted lines to illustrate that the logic can be implemented as software or hardware, and that if it is implemented as software, it can reside anywhere in a method call path between an API call requesting a remote resource, and a call to the hardware component 510. Thus, the logic 514 is implemented, for example, when a connect method is called before, or a disconnect method is called after an application requests a resource that is a remote resource.

The logic for managing the shared connection 518 saves state about which application(s) are using the shared connection, and maintains that connection so long as at least one application is using the connection. For example, the logic 518 saves a process identification for each process requesting the shared connection, and as each process releases or disconnects the connection, the state is updated. When the last process releases or disconnects the connection, the logic 518 allows the disconnection to occur, or allows a disconnection call to disconnect the shared connection. Additionally, the logic determines whether a running application has died or completed running without releasing the connection. Once all processes that requested the connection 508 have died, completed, or released the connection, the shared resource 508 is disconnected.

In the example where the device is a cellular (e.g., wireless) phone, the applications 520, 522 are such applications as an e-mail, a web browser, a camera, or voice services. In such a case, the network connection 508 is wireless, the network is a wireless telephone network, and the node 506 is a transmitter/receiver on the network. Of course, the wireless telephone network provides access to other networks (e.g., Internet). Thus, existing networks provide many resources to the plural applications once the described application connection sharing logic is in place.

### Exemplary Connector

In one example, a device includes a connector component. The connector component is a set of parameters that are provided to a dialer on a connection call. The parameters tell the dialer what phone number to call, how to dial the phone number, what hardware component (e.g., modem) to use, dialing properties (e.g., “9” for outside line, etc.), what credentials to use (e.g., user, device, etc.), and what parameters to input into the API for the dialer (e.g., configuration information). It includes the information needed to establish the connection 508 that is later shared when requested by a second application.

The connection information is saved in memory (e.g., stored in the registry), and when a connection is requested, the connector is used to tell which information to use to dial and create the connection. Further, in cases where one connection fails, the connector contains the “next best” connector information for a dialer to try.

In one example, the connector is implemented by a dialer component and is invoked by the dialer in order to obtain configuration information for requesting the connection.

### Exemplary Communicating Components

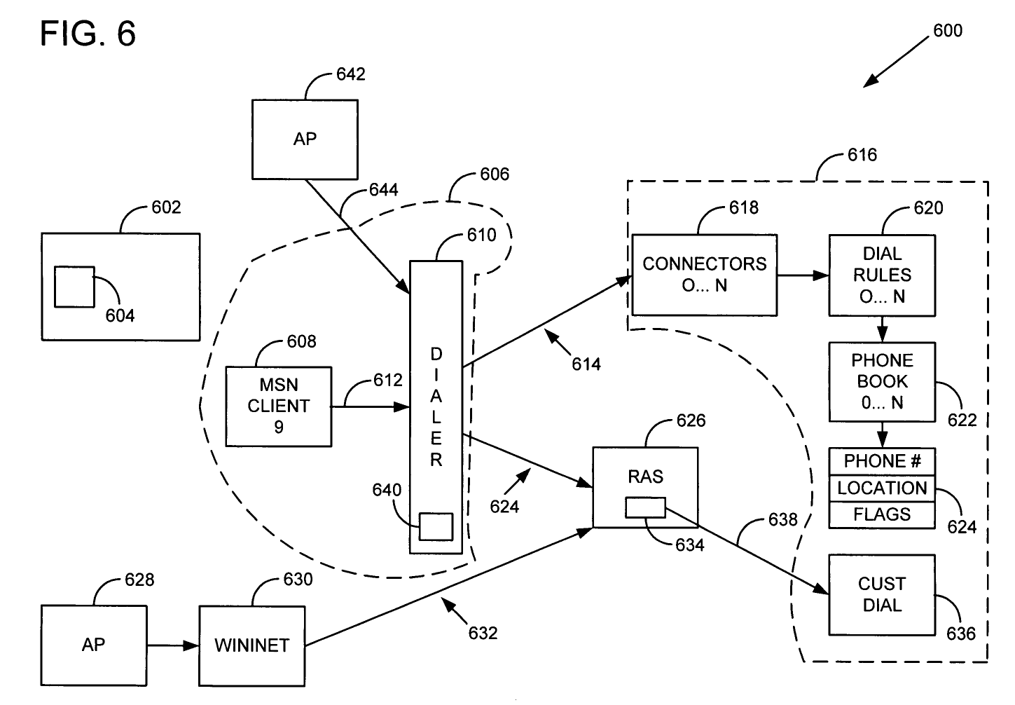

FIG. 6 is an exemplary block diagram showing a system of components 600 involved in managing a multi-client shared connection.

In a first example, a computer user clicks on a screen 602 icon 604 representing an Internet connection (e.g., a butterfly icon representing a Microsoft Network client). Clicking this icon causes the computer to load the Microsoft Network Services version 9 (MSN 9) environment 606, including a user interface software component called an MSN 9 client 608, and a dialer component 610 (e.g., Connection Manager). Next, the MSN 9 client 608 displays the user “files,” and if a clicked file represents a dial-up user, the MSN 9 client will call a connect( ) method 612 on the dialer component 610. In this example, the dialer component exposes a connection( ) method via the Dialer COM Interface.

In one example, data for a connector is obtained by a connection manager from a data store. For example, a dialer component calls a method 614 on a registry 616 to identify a connector. In many computer systems a system service is provided to programmers for storing, altering, and obtaining information and programs in a system registry. In this example, the registry contains one or more (“n”) connectors 618 that can be used to establish a connection to the network. The registry connector 618 contains a data property known as the “current connector.” Each connector (i.e., 0 . . . n) includes a set of rules 620 (e.g., “disable call waiting,” “dial 9 for outside line,” etc.) which should be used for that current connector. Additionally, the connector component calls a phone book component 622 to identify a phone number for that current connector, and each phone number includes the number to dial, a geographic location such as “Atlanta” or “New York,” and flags that indicate whether the number should be dialed using an area code prefix, and/or the number “1” before the prefix for long distance. The information gathered at the dialing rules 620, the phone book 622, and the phone number flags 624, is used to assemble a number sequence to dial for the current connection. This information is returned to the dialer as a result of the connector call 614. Optionally, the registry also returns that users name and password from the connector call 614. This information is passed back to the dialer.

Next, the dialer component 610 calls a dial method 624 on a remote access service 626 (e.g., a RAS component). The dial call 624 includes parameters comprising the numbers required by a RAS component to establish a connection (e.g., phone number, password, prefix, etc.). The RAS component 626 returns a “HRASCONN” handle to the dialer component 610. This HRASCONN handle becomes the ticket used by the dialer to refer back to the connection, for example to disconnect the connection. The return from the dial call 624 can also contain other information, such as error codes (e.g., connection not established, invalid user name or password, etc.). Thus, the HRASCONN handle holds state regarding the status of the connection (e.g., bytes-up, bytes-down, bit rate, etc.).

When the application is finished using the connection, the MSN 9 client 608 calls disconnect on the dialer component 610, and if no other applications are using the connection, the dialer component calls a disconnect method 624 on the RAS component.

In a second example, an application 628 requests access to a remote resource. This request triggers a call on the RAS component 626 either directly, or through a series of calls, for example, as discussed with respect to FIG. 3. In such an example, the application directly, or through WININET 630 will determine how RAS is configured 632 to connect to the Internet. For example, in a Microsoft Windows operating environment, if a registry configuration indicates dial-up access, and a Default Dialup connection 634 is set to the MSN connectoid, then the registry 638 will indicate that a “custom dialer” 636 should be used to establish the connection. In such an example, when RAS calls a connect on the connectoid 634, the connectoid will call a method on the registry 638 and identify the custom dialer called “CUSTDIAL.DLL.” A method in the “CUSTDIAL.DLL” called “RASCUSTOMDIAL( )” determines whether the MSN 9 client 608 is installed on the computer by checking the registry. If the MSN 9 client 608 is installed on the computer, then the connection proceeds as discussed in the first example. Thus, applications requesting connection from the RAS component are directed back through the dialer to implement the shared connection technology. In such a case, the MSN 9 client will be loaded and run starting from the “tiles” as discussed in the first example.

If the MSN 9 client is not installed on the computer, then the “RASCUSTOMDIAL( )” method will bypass the MSN 9 client 608, and pass the connection request directly to the dialer component 610, as otherwise discussed in the first example. Thus, in these two examples a connection request goes through the MSN 9 client 608, or is redirected to the dial component via CUSTDIAL 636.

When the application 628 has completed use of the remote resource, the application will call disconnect on the RAS component, either directly or indirectly through WININET 630. As before, the disconnect will be redirected via the custom dialer 636 to the dialer component 610.

Thus, some applications are designed to call a RAS interface which results in the dialer component being invoked via the “RASCUSTOMDIAL( )” method of registered “CUSTDIAL.DLL,” while other applications utilize the MSN 9 client which invokes the dialer component directly.

Finally, an application 642 can also request 644 a connection or disconnection directly from the dialer component by calling the connection/disconnection method described above as exposed by the Dialer COM interface.

In the described scenarios, connection and disconnection requests are directed to the dialer component which contains logic 640 for managing the connection for plural client applications (i.e., processes).

### Exemplary Multiple Process Connection States

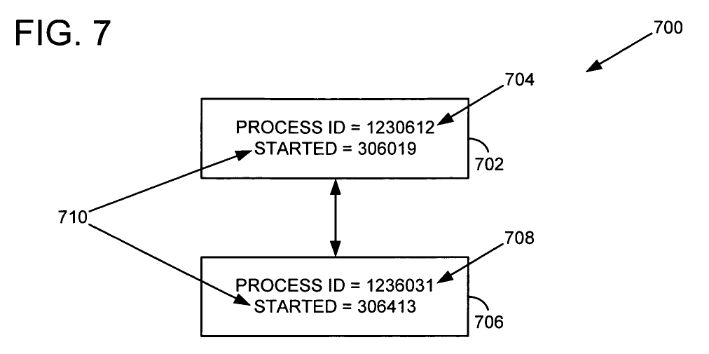

FIG. 7 is an exemplary diagram of a data structure holding state indicating multiple client processes sharing a connection.

As previously discussed, plural client processes may require access to remote resources via a shared connection (e.g., a shared connection). Upon receiving a connection request, state information about a requesting process is stored in a data structure. The data structure can be implemented as a linked list, a table, an array, or other data structure. In this example, the data structure is a linked list 700.

When a process calls a connection method to obtain access to a remote resource, the connection is established and a record indicates which process requested the connection 704 (e.g., by process id or other unique identifying information).

When a process requests a disconnection, the record 702 is removed for that process, and if no other processes maintains a connection as determined by other records 706 in the list, then the connection is terminated.

When a process 708 requests a connection while another process holds a connection 704, as determined by the list 704, 708, then the second process information is added as a record in the list, but the plural processes share the connection.

When all processes have been removed from the list, the shared connection is terminated. Using this logic, the share connection remains open even when a disconnection is requested by a process, so long as at least one other process remains on the list.

In another example, the records of the linked list also include a start field 710. The start field indicates a value for the time a process requested the connection. This time value is useful in case a process terminates or fails before a disconnect method is called by the process. After a threshold period of time after the indicated start time 710, the running process ids are checked (e.g., via an operating system service for determining active processes) to see if a process in the list 704, 708 is still running. If not, that process is removed from the list 700, and the connection is terminated if no other active processes are on the list.

Thus, the first connect call establishes a connection and adds a record of the requesting process to the list. Subsequent connection requests add records to the list. Disconnect method calls remove records from the list. After a threshold period of time from a start time 710, processes are checked to see if they are still active. Inactive processes are removed from the list. When no records remain, the connection is terminated.

### Exemplary Connection Method

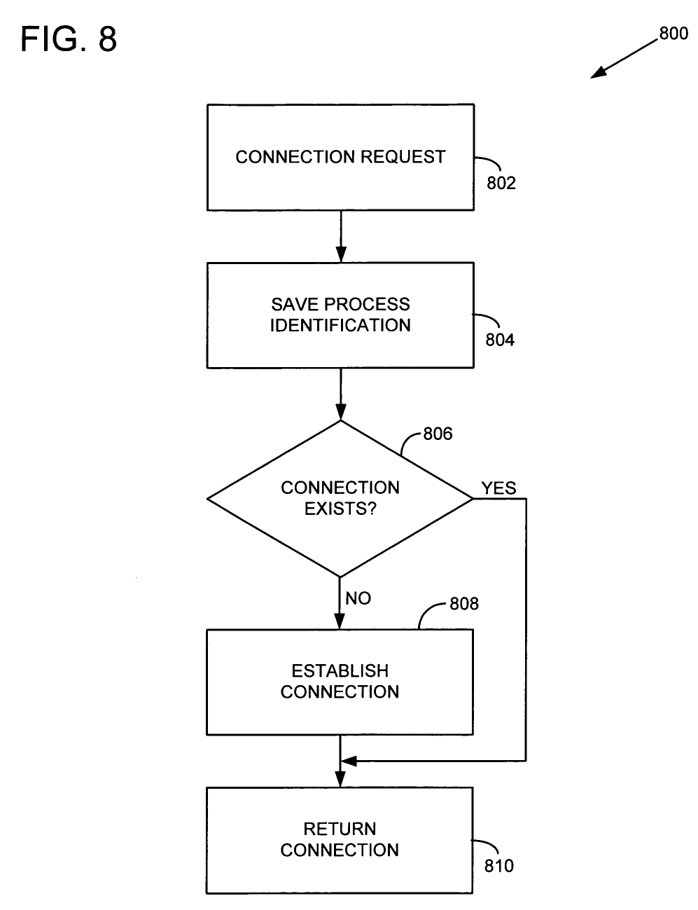

FIG. 8 is a flow chart 800 of a method for managing a connection.

At 802, the method receives a connection request. For example, the connection request is received directly from a process requiring a connection to access a remote resource, or is received indirectly from the process via a system service supporting communications with remote resources. In one example, the request is a method call which includes an input parameter. For example, the input parameter is an identifier (e.g., a process identifier or other unique identifier) that is used to identify the application component, thread, or process requesting the connection.

At 804, the method saves an identifier of the connection request. For example, the identifier can be saved in a data structure. The identifier is useful later, for example, to help identify which entity is requesting a disconnect. In another example, the identifier is a process identification of the process requesting access to remote resources. In such a case, the process identification is saved in a data structure. A saved process identification will be used, for example, to keep track of how many and which processes have requested and are still using connections.

At 806, the method determines whether the requested connection is already established (e.g., on behalf of an earlier connection request). If no connection is yet established then the method proceeds to step 808. If a connection is established, the method proceeds to step 810.

At 808, the method establishes a connection. In one example, the connection is established from the device to a remote Internet service provider via a dial-up modem connection, and the remote resource is obtained from the ISP or at other web servers via the ISP. In one example, the connection is established by calling a dial ( ) method on a RAS component.

In another example, the connection is established from the device to a wireless network via a wireless protocol (e.g., cellular, blue tooth, 802.11, etc.). The connection then serves as a pipe for communications between application(s) on the device and remote resources on the Internet, intranet, wireless network, etc. Communications (e.g., data, voice, etc.) passing across the established connection is routed to the proper application on the device using known methods (e.g., OSI Seven Layer Model, TCP/IP, etc.).

At 810, the connection call request returns. In one example, the connection call return includes an output parameter used by the calling entity to communicate over the established connection.

### Exemplary Disconnect Method

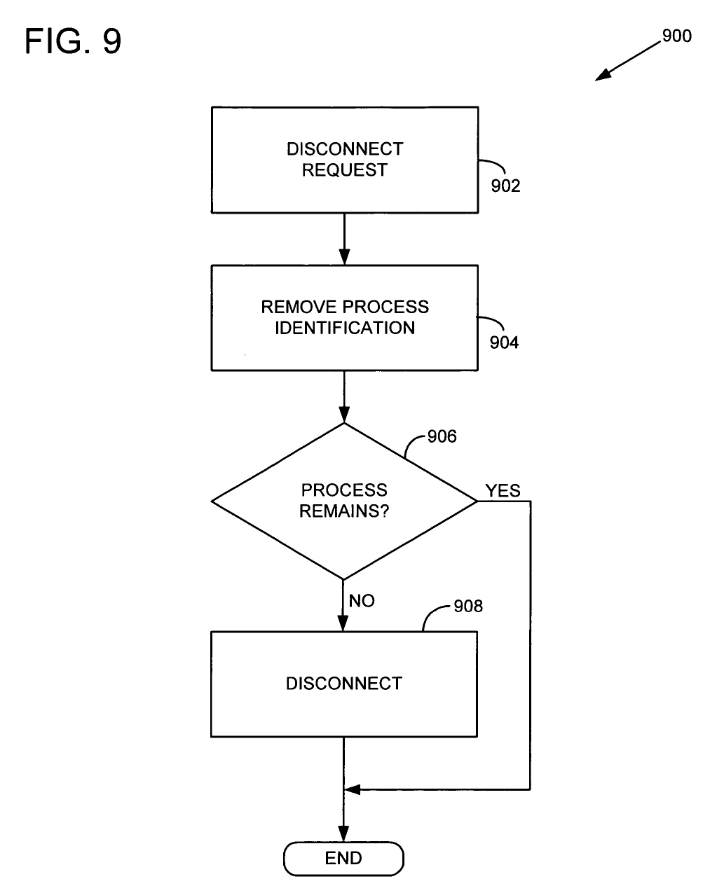

FIG. 9 is a flow chart 900 of a method for managing disconnections.

At 902, the method receives a disconnection request. For example, the disconnection is received directly from a process that previously requested a connection (e.g., 802), or is received from the process indirectly via a system resource supporting communications with remote resources. In one example, the disconnection includes an input parameter for a process requesting disconnection. In another example, a unique identifier was returned upon the connection request (802), and the disconnection request includes the unique identifier.

At 904, the method removes the unique identifier or process identification from a data structure (e.g., where it was stored upon a connection request 804).

At 906, if the data structure indicates that at least one other connection request identifier exists, then the method completes. However, if the identifier removed at step 904 was the last identifier in the data structure, then the method continues at step 908.

At 908, the connection is terminated.

### Exemplary Terminated Process

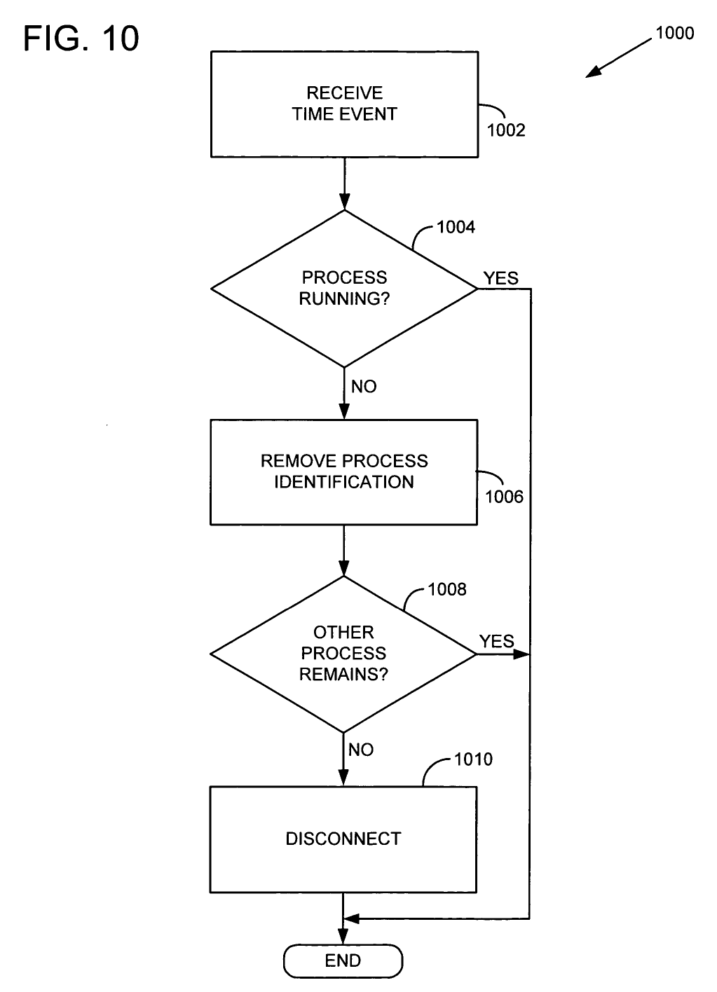

FIG. 10 is a flow chart 1000 of an exemplary method for managing a terminated process sharing a connection.

As an additional feature of step 804, the time a process requests a connection is noted in the data structure. At some threshold period of time later (e.g., one second, one minute, one hour, etc.), a time event is generated in order to determine if a process sharing the connection is still active.

At 1002, a time event is generated.

At 1004, the method checks the operating system services to see if the process requesting the connection is still running. If the process is still running, the method completes.

At 1006, if the process has terminated, whether gracefully without calling disconnect or by some unexpected failure, the process identification is removed from a data structure (e.g., 804).

At 1008, if at least one other process identifier exists in the data structure after the terminated process identification is removed, the method completes.

At 1010, since the terminated process was the last process using the connection, the connection is terminated.

### Exemplary Connection Management

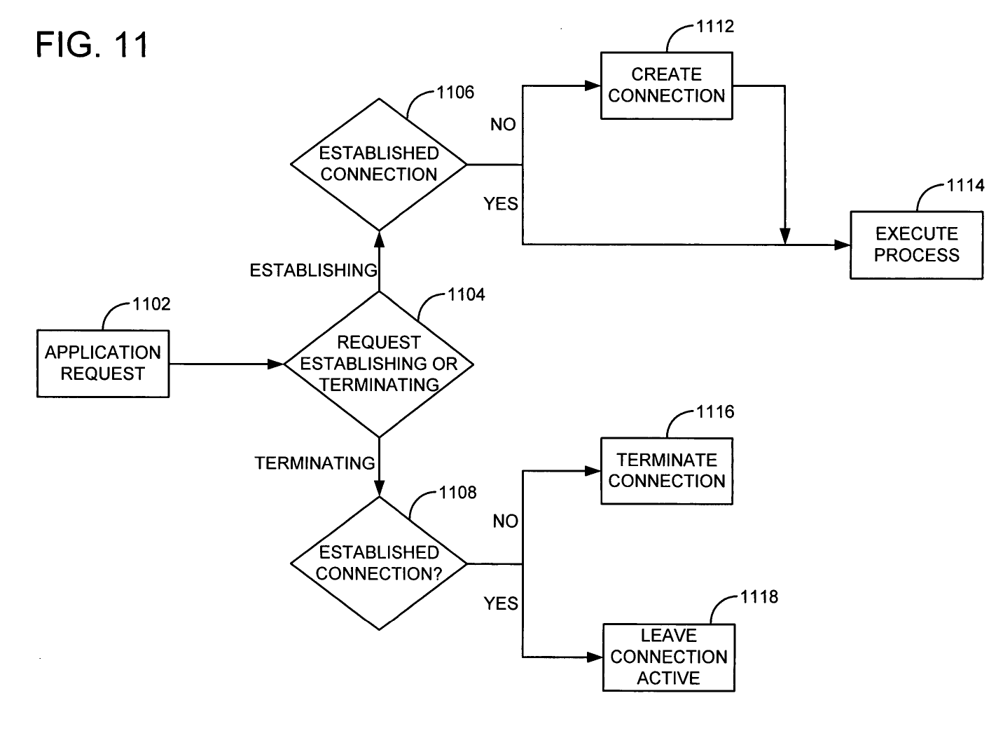

FIG. 11 is a flow chart of an exemplary method for managing a shared connection.

At 1102, a request is received from an application.

At 1104, if the request 1102 is for a connection, the method resumes at 1106, otherwise the method resumes at 1108.

At 1106, if another application has already established a connection, the method resumes at 1114, otherwise the method resumes at 1112.

At 1114, since the connection is established, the requesting application executes a remote resource request.

At 1112, the connection is established, and then the application executes a remote resource request 1114.

At 1108, if other applications have an established connection, then the connection is left open 1118, otherwise the connection is closed 1116.

### Exemplary Remote Access Connection

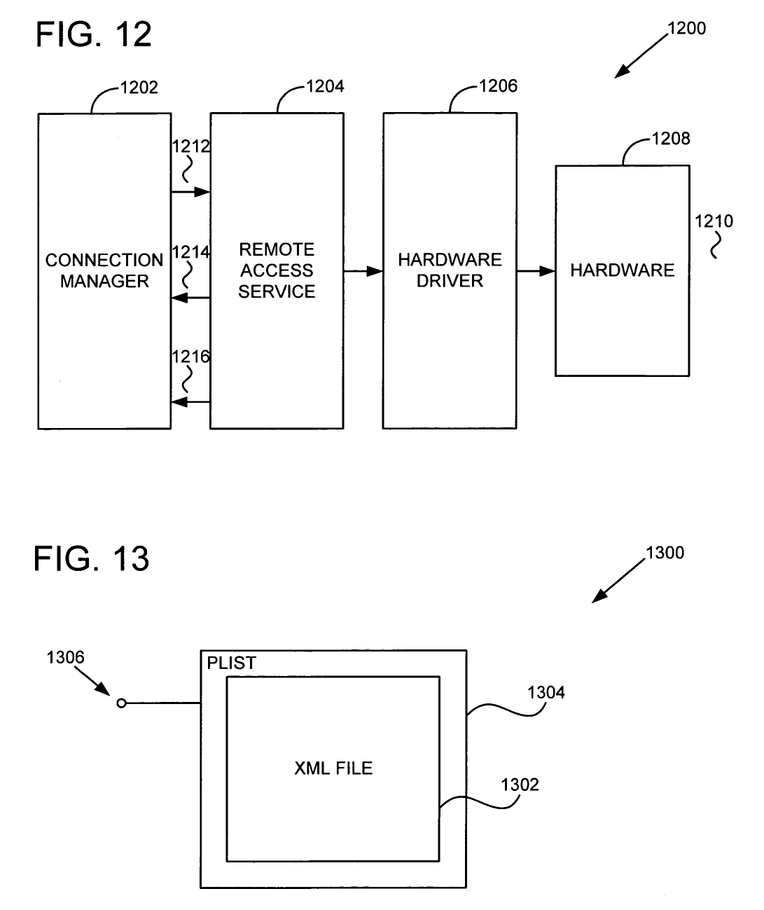

FIG. 12 is a block diagram of exemplary system components 1200 establishing a connection. As shown, a device comprises a connection manager 1202 (e.g., a dialer), a remote access server 1204, a hardware driver 1206, and an internal or external hardware component 1208 for establishing and implementing a connection 1210, wireless or otherwise.

A connection manager comprises software that receives connection or disconnection requests caused by applications requesting remote resources. The connection or disconnection request received by the connection manager is received from a method call by an application. In another example, the connection or disconnection request received by the connection manager is received by a system service that receives a resource request from an application. In such an example, after the system service determines that the resource is remote, the system service issues a connection request on the connection manager 1202.

A connection manager assembles information (e.g., parameters) required to call a dial method on a remote access service 1204. In an example, when the connection will be a dial-up connection, the assembled information includes a telephone number and possibly and area code, a user identification, or a password. In other examples, the assembled information will include information about the quality or reliability of service (e.g., bandwidth) required for the requested connection. The types of information gathered are well known and varied for the different types of requested connections for wireless connections and otherwise, whereas this technology manages sharing connections by plural applications. Once the information is assembled, the connection manager calls a method on the remote access service requesting a connection. The remote access service returns information to the connection manager. The returned information indicates whether a connection was established. In another example, if the connection is established, the remote access server also returns information about the connection (e.g., type of connection, dial-up, wireless, bandwidth, protocol, etc.). In one example, a connection manager stores information about the connection, and later if another application requests a connection, the connection manager compares this information to determine whether other requesting applications can share an existing connection.

In one example, when no connection is established, the remote access service returns information to the connection manager. In one such example, the remote access service returns a standard code indicating why the remote access server was unable to establish a connection. Such standard codes are also referred to as error codes and are very numerous and diverse in nature (e.g., hardware failure, line busy, no dial tone, wireless service out of range, password incorrect, requested service not available, etc.).

A remote access service received a connection request and invokes certain methods on a hardware driver to establish and maintain a connection. In one example, a remote access service invokes methods on a hardware driver according to a standard. For example, Unimodem is a driver standard for communications hardware (e.g., modems) interfacing with connection requests on Microsoft Windows platforms. In this regard, a connection manager (e.g., dialer) calls a remote access service without regard to what hardware driver or hardware is supporting the connection.

Often a hardware component 1208 manufacturer writes a software program designed to communicate with the hardware component. This software is often called a hardware driver 1206. The hardware driver receives communication's method calls formed according to a standard (e.g., Unimodem) and forwards them to the modem where they are sent out over a medium 1210 (e.g., a cable, dial-up connection, radio frequency, etc.). The hardware transmits and receives communications with other remote hardware over the medium 1210, according to a communications protocol. Thus, the hardware driver contains methods that it expects a remote access service to call according to a communications standard.

In the Microsoft Windows operating environment, the remote access service is the Remote Access Service software (i.e., RAS component) from Microsoft Corporation. Other devices not using the RAS component may create their own remote access service, and it would have a possibly different set of codes used to identify errors returned from a call to the remote access service.

For example, on an Apple Macintosh platform, a remote access service is called Open Transport (OT), and OT hosts a separate known communications standard and error codes. In such an example, the connection manager assembles information and requests an OT connection accordingly, and receives OT error codes.

### Exemplary Connector Data Storage

As previously stated, in one example a connection manager (e.g., dialer component) assembles information for input to a remote access service connection request. A previous example provided this information via a system registry. However, in another example the information is provided via a database, a file, or other data structure. In one such example, the information is provided as an XML file. For example, in the Apple Macintosh platform, the information is stored in an XML file.

FIG. 13 is a block diagram of an XML file 1300 for storing connector information. The XML file 1302 comprises a schema for defining data properties stored in the file.

A programmer creating a connection manager stores, updates, and obtains information associated with configuring a connector in the XML file. The schema is used to create methods that traverse or parse the XML file and store, update or obtain information required to issue a connection call on the remote access component, and maintain the features discussed.

In one example, a Macintosh platform exposes an interface used by programmers to store and access files associated and including their programs.

The interface is called a PList 1304, in XML, and has interfaces 1306, that the connection manager calls into to manage connector information. For example, the connector 1018, the dial rules 1020, the phone book 1022, and the location 1024 are accessible via the PList interface 1306 on the Macintosh platform.

Thus, the connector information is stored in an XML file for access as needed by a connection manager.

### Computing Environment

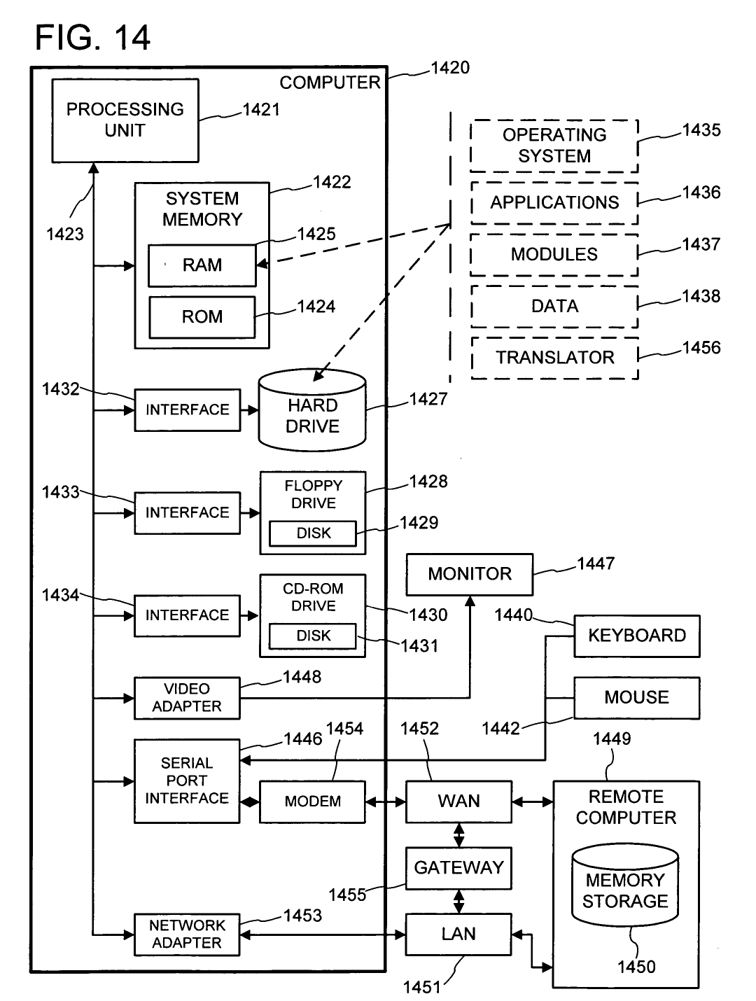

FIG. 14 and the following discussion are intended to provide a brief, general description of a suitable computing environment for an implementation. While the invention will be described in the general context of computer-executable instructions of a computer program that runs on a computer and/or network device, those skilled in the art will recognize that the invention also may be implemented in combination with other program modules. Generally, program modules include routines, programs, components, data structures, etc. that perform particular tasks or implement particular abstract data types. Moreover, those skilled in the arts will appreciate that the invention may be practiced with other computer system configurations, including multiprocessor systems, microprocessor-based electronics, minicomputers, mainframe computers, network appliances, wireless devices, and the like. The extensions can be practiced in networked computing environments, or on stand-alone computers.

With reference to FIG. 14, an exemplary system for implementation includes a conventional computer 1420 (such as personal computers, laptops, servers, mainframes, and other variety computers) includes a processing unit 1421, a system memory 1422, and a system bus 1423 that couples various system components including the system memory to the processing unit 1421. The processing unit may be any of various commercially available processors, including Intel x86, Pentium and compatible microprocessors from Intel and others, including Cyrix, AMD and Nexgen; Alpha from Digital; MIPS from MIPS Technology, NEC, IDT, Siemens, and others; and the PowerPC from IBM and Motorola. Dual microprocessors and other multi-processor architectures also can be used as the processing unit 1421.

The system bus may be any of several types of bus structure including a memory bus or memory controller, a peripheral bus, and a local bus using any of a variety of conventional bus architectures such as PCI, VESA, AGP, Microchannel, ISA and EISA, to name a few. The system memory includes read only memory (ROM) 1424 and random access memory (RAM) 1425. A basic input/output system (BIOS), containing the basic routines that help to transfer information between elements within the computer 1420, such as during start-up, is stored in ROM 1424.

The computer 1420 further includes a hard disk drive 1427, a magnetic disk drive 1428, e.g., to read from or write to a removable disk 1429, and an optical disk drive 1430, e.g., for reading a CD-ROM disk 1431 or to read from or write to other optical media. The hard disk drive 1427, magnetic disk drive 1428, and optical disk drive 1430 are connected to the system bus 1423 by a hard disk drive interface 1432, a magnetic disk drive interface 1433, and an optical drive interface 1434, respectively. The drives and their associated computer-readable media provide nonvolatile storage of data, data structures, computer-executable instructions, etc. for the computer 1420. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 1425, including an operating system 1435, one or more application programs 1436, other program modules 1437, and program data 1438; in addition to an implementation 1456.

A user may enter commands and information into the computer 1420 through a keyboard 1440 and pointing device, such as a mouse 1442. These and other input devices are often connected to the processing unit 1421 through a serial port interface 1446 that is coupled to the system bus, but may be connected by other interfaces, such as a parallel port, game port or a universal serial bus (USB). A monitor 1447 or other type of display device is also connected to the system bus 1423 via an interface, such as a video adapter 1448. In addition to the monitor, computers typically include other peripheral output devices (not shown), such as speakers and printers.

The computer 1420 operates in a networked environment using logical connections to one or more remote computers, such as a remote computer 1449. The remote computer 1449 may be a server, a router, a peer device or other common network node, and typically includes many or all of the elements described relative to the computer 1420, although only a memory storage device 1450 has been illustrated. The logical connections depicted include a local area network (LAN) 1451 and a wide area network (WAN) 1452. Such networking environments are commonplace in offices, enterprise-wide computer networks, intranets and the Internet.

When used in a LAN networking environment, the computer 1420 is connected to the local network 1451 through a network interface or adapter 1453. When used in a WAN networking environment, the computer 1420 typically includes a modem 1454 or other means for establishing communications (e.g., via the LAN 1451 and a gateway or proxy server 1455) over the wide area network 1452, such as the Internet. The modem 1454, which may be internal or external, is connected to the system bus 1423 via the serial port interface 1446. In a networked environment, program modules depicted relative to the computer 1420, or portions thereof, may be stored in the remote memory storage device. It will be appreciated that the network connections shown are exemplary and other means of establishing a communications link between the computing devices may be used, wireless or otherwise.

### Alternatives

Having described and illustrated the principles of our invention with reference to illustrated examples, it will be recognized that the examples can be modified in arrangement and detail without departing from such principles. Additionally, as will be apparent to ordinary computer scientists, portions of the examples or complete examples can be combined with other portions of other examples in whole or in part. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa. Techniques from one example can be incorporated into any of the other examples.

In view of the many possible embodiments to which the principles of our invention may be applied, it should be recognized that the details are illustrative only and should not be taken as limiting the scope of our invention. Rather, we claim as our invention all such embodiments as may come within the scope and spirit of the following claims and equivalents thereto.

1. In a device including plural applications requesting remote resources, a method of managing overlapping connection sessions created to support access to remote resources by said plural applications, the method comprising:
receiving a connection request comprising a process identification and saving the process identification in a data structure;
establishing a connection upon receiving a connection request when no connection exists;
receiving a disconnection request comprising a process identification and removing the disconnecting process identification from the data structure; and
terminating the connection upon receiving a disconnection request when no process identifications remain in the data structure after removing the disconnecting process identification.

2. The device of claim 1 further comprising:
saving a time that a connection request was received;
after a threshold period after the time, removing a process identification from the data structure if a process associated with the process identification has terminated; and
terminating the connection when no process identifications remain in the data structure after removing the identification of the terminated process.

3. The device of claim 1 wherein the device is a computer and the connection is a dial-up connection.

4. The device of claim 1 wherein the device is a wireless device and the connection is a wireless connection.

5. The device of claim 4 wherein the wireless device is a telephone.

6. The device of claim 5 wherein the wireless device is a hand held computer.

7. A computerized method comprising:
receiving a request for a connection to a remote resource;
saving in a data structure, an identifier of the request for a connection;
upon receiving a request for connection, creating the connection when the connection is not already established;
receiving a request for a disconnection from a remote resource;
deleting from the data structure, an identifier of the request for the disconnection;
disconnecting the connection upon a disconnection request when the deleted identifier is the last identifier of a request for a connection in the data structure.

8. The method of claim 7 further comprising:
removing an identifier of a request for a connection from the data structure after a period of time after the request is made if a process associated with the identifier has terminated.

9. The method of claim 7 wherein a request for a connection originates from an application and the remote resource is a web server.

10. The method of claim 9 wherein the connection is a dial-up connection between a modem and an Internet service provider.

11. The method of claim 7 wherein the method is running on a wireless device with plural applications sending the connection requests and communicating with remote resources over the connection.

12. A computer system comprising:
a processor coupled to memory and a hardware device for communicating with remote resources;
software in memory and comprising:
an operating service for receiving system service requests via an application services interface;
plural applications requesting remote services from the operating service via the application services interface;
a connection manager for establishing via the hardware device a connection shared by plural applications communicating with remote resources over the connection and for maintaining the connection when an application requests a disconnection while another application is still using the connection.

13. The system of claim 12 wherein the connection manager disconnects the connection when a last application using the connection calls disconnect.

14. The system of claim 12 wherein the connection manager maintains a list of applications that have requested the connection.

15. The system of claim 14 wherein the connection manager disconnects the connection when an application requests a disconnect and no other application is on the list.

16. The computer system of claim 12 wherein the system is a personal computer.

17. The computer system of claim 12 wherein the connection is wireless.

18. A computer-readable medium comprising executable instructions for performing a method comprising:
creating a connection when a process request communicating with remote resources requiring the connection;
storing identifiers of processes requesting communicating with remote resources via the connection;
removing an identifier of a process from the stored identifiers when the process requests a disconnection;
maintaining the connection when a process requests a disconnection when stored identifiers indicate another process is communicating with remote resources via the connection; and
disconnecting the connection when a process requests a disconnection when stored identifiers indicate no other process is communicating with remote resources via the connection.

19. The computer-readable medium of claim 18 further comprising executable instructions for removing an identifier of a process from the stored identifiers when the process has terminated.

20. The computer-readable medium of claim 18 further comprising executable instructions for periodically removing identifiers of processes from the stored identifiers when the processes have terminated without requesting a disconnect.
